(19) United States
(12) Patent Application Publication
(10) Pub. No.: US 2011/0270881 A1
(43) Pub. Date: Nov. 3, 2011

(54) SYSTEM AND METHOD FOR ANALYZING HISTORICAL AGGREGATE CASE RESULTS FOR A COURT SYSTEM

(76) Inventor: Joseph W. Borton, Meridian, ID (US)

(21) Appl. No.: 12/772,812

(22) Filed: May 3, 2010

(51) Int. Cl. G06F 17/30

(52) U.S. Cl. 707/771; 707/769; 707/E17.014

(57) ABSTRACT

A system and method for a court statistics search and analysis service offered to legal professions and other users on a subscription basis that provides historical, statistical data related to lawsuits filed in a system of courts of law. The courts of law may be in a plurality of states and may be federal or state courts. Court documents and records including statistical and other data related to lawsuits filed and tried in the courts of law provided by government agencies on public web sites are retrieved over a network. Lawsuit related data is extracted from the retrieved documents and stored in a database. The database may then be accessed by one or more users via a terminal over a network to provide a historical profile of the dispositions of a plurality of lawsuits filed in the courts of law over a desired period of time.

### FIELD OF THE DISCLOSURE

The present application relates generally to a system and method of analysis and dissemination of historical aggregate case results in a court system and, more specifically, to a system and method for searching historical court documents to provide and analyze statistical data related to all cases filed in a court system and display the search and analysis results to a user.

### BACKGROUND OF THE DISCLOSURE

The American legal system relies heavily on written judicial opinions, the written pronouncements of judges, to articulate or interpret the laws governing resolution of disputes. These written judicial opinions are reported in numerous texts include reports on criminal and civil cases decided in state or federal courts. However, many of the cases which are filed in state or federal courts are not reported in published texts. Additionally, written opinions can be long and may require significant study and time to determine the result in each case. The current method of reporting case results creates additional work legal professionals to determine the aggregate case results and trends for all cases filed in a particular court or court system.

More recently some court system, either at the state, county or district level, are publishing results and statistics for all cases filed in a court system. These court documents will typically provide, in criminal cases for example, the judge, the charge, the charging agency, the prosecuting attorney, the result, guilty or not guilty for example, and the like, including a date field, for all cases filed in a court system. What is needed then, are new tools and methods to search these documents and identify desirable statistical data to enable legal professionals or other users to quickly and accurately assess trends and predict a probable outcome for future cases in the same court system.

### SUMMARY

The present application discloses a system and method for searching historical court documents to provide and analyze statistical data related to all cases filed in a court system and display the search and analysis results to a user. The disclosed system and method contemplate gathering desired statistical data made available over one or more public networks, such as the internet, for example, and storing the retrieved data in a database. A user then connects to the system over a network, such as the internet, for example. Through a web browser or other user interface, a server presents a user with a screen or web page that allows the user to select specific search and analysis tasks to be performed by the system.

In one embodiment of the present disclosure, a method of searching and disseminating statistical information relating to lawsuits filed in a plurality of courts of law comprises the steps of retrieving statistical documents generated by a plurality of courts of law wherein the statistical documents relate to lawsuits filed, tried and/or closed in the at least one courts of law; reviewing and extracting statistical data from the retrieved statistical documents in accordance with a predetermined set of search criteria, wherein the extracted statistical data includes at least a lawsuit identifier, the location of the court of law that tried the lawsuit, the cause of action, the date that the lawsuit was closed, and the disposition of the lawsuit for each lawsuit filed in the plurality of courts of law. The extracted statistical data is stored in a database that is accessed by a plurality of user terminals which communicate with the database via a network, and at least a portion of the stored extracted statistical data from the database is provided over the network to at least one user located at a user terminal in response to a user search request.

Another aspect of the present disclosure includes analyzing the extracted statistical data to determine at least one predefined relationship between the total number of lawsuits for a selected cause of action filed in a selected group of courts of law of the plurality of courts of law and the disposition of each lawsuit filed and closed in the selected group of courts of law during a selected time period. Statistical data from the database is provided to the at least one user terminal indicative of the relationship between the number of lawsuits for a selected cause of action filed in the selected group of courts of law and the disposition of each lawsuit filed and closed in the selected group of courts of law during the selected time period

Another aspect of the present disclosure includes analyzing the extracted statistical data to determine at least one predefined relationship between the total number of lawsuits for a selected cause of action filed in a selected group of courts of law and the disposition of each such lawsuit tried by each judge of a plurality of selected judges during the selected time period. Statistical data from the database is provided to the at least one user terminal indicative of the relationship between the number of lawsuits for the selected cause of action filed in the selected group of courts of law and the disposition of each such lawsuit tried by each judge of the plurality of selected judges during the selected time period.

In another embodiment of the present disclosure, a system for searching and disseminating statistical information relating to lawsuits filed in a plurality of courts of law includes a server coupled to a public repository web site via a network. The public repository stores a plurality of statistical documents, each of the statistical documents including data related to a lawsuit filed in one of a plurality of courts of law. The server is operative to retrieve and store the statistical documents in memory. A search module coupled to the server is operative to search and extract statistical data from the retrieved statistical documents in accordance with a stored set of predetermined search criteria. The extracted statistical data includes at least an identifier of a lawsuit, the location of a court of law that tried the lawsuit, the cause of action for the lawsuit, the date that the lawsuit was closed, and the disposition of the lawsuit for each lawsuit filed in the plurality of courts of law. The extracted statistical data is stored in a database coupled to the server. The server is operative to access the database in response to a search request. The server is coupled to at least one user terminal over a network and is operative to provide at least a portion of the stored extracted statistical data to at least one user terminal in response to a user search request.

### BRIEF DESCRIPTION OF THE DRAWINGS

The following figures, in which like numerals indicate like elements, form part of the present specification and are included to further demonstrate certain aspects of the present disclosure. The disclosure may be better understood by reference to one or more of these figures in combination with the detailed written description of specific embodiments presented herein.

FIG. 1 is a block diagram illustrating exemplary components in an embodiment of a system for searching historical court documents to provide and analyze statistical data, and display the results to a user;

FIG. 2 is a diagram illustrating the high level architecture of the system shown in FIG. 1;

FIG. 3 is a table illustrating the content of the case summary pages retrieved from court system public website as shown in FIG. 2;

FIG. 4 is a diagram illustrating a search refinement process for a search and analysis task selection from a user of the system shown in FIG. 1;

FIGS. 5A, 5B, 5C and 5D are diagrams of an exemplary screens presented to a user for displaying results for a search and analysis task selection from a user of the system shown in FIG. 1;

FIG. 6 is a flow chart illustrating the registration process for a new user of the system shown in FIG. 1;

FIG. 7 is a flow chart illustrating the login process for a user of the system shown in FIG. 1; and

FIG. 8 is a flow chart illustrating the search and analysis process for the system shown in FIG. 1;

These and other embodiments of the present application will be discussed more fully in the description. The features, functions, and advantages can be achieved independently in various embodiments of the claimed invention, or may be combined in yet other embodiments.

### DETAILED DESCRIPTION

One or more illustrative embodiments are described below. Not all features of an actual implementation are necessarily described or shown for the sake of clarity. It is to be understood that both the foregoing background and summary descriptions and the following detailed description are exemplary and explanatory only and are not restrictive of the embodiments as claimed.

The present application discloses a system and method that allows a user to perform a task-based search and analysis of historical statistical data relating to criminal and/or civil cases published by one or more court systems. All state and federal courts within a plurality of the states of the United States could be included in the system. Courts within an individual state could be grouped by district or county. The disclosed system and method contemplate gathering desired statistical data made available over one or more public networks, such as the internet, for example, and storing the retrieved data in a database. A user then connects to the system over a network, such as the internet, for example. Through a web browser or other user interface, a server presents a user with a screen or web page that allows the user to select specific search and analysis tasks to be performed by the system. The user selects pre-loaded search criteria from drop down menus, for example, that will present the user with all available search criteria. The various search criteria will be selected to allow a user to determine trends for past cases filed in a particular court system or an individual court within a court system. The search criteria may include, for example, the names of all judges and prosecuting attorneys, all charging agencies, all, or at least the most common, types of criminal charges (for criminal cases), causes of action (for civil cases), and case results, guilty or not guilty (for criminal cases), for example, and the like. Analysis of the retrieved data based on the search criteria selected will be performed by the system and the search results will be displayed to the user in one or more formats best suited to the type of data retrieved. Data may be displayed as tables, charts or graphs, for example. It is contemplated that the search and analysis services provided by the disclosed system and method will be offered to users on a subscription basis and on a state by state basis.

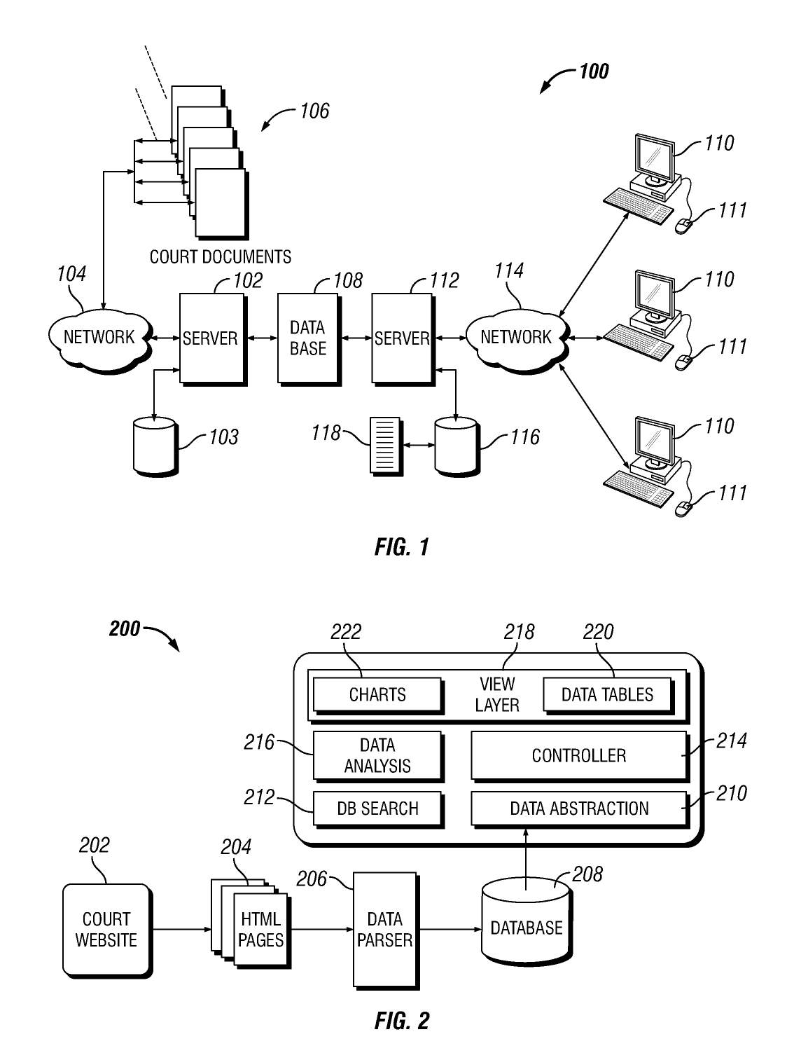

Referring now to FIG. 1, a system 100 for searching historical court documents and records relating to criminal and/or civil lawsuits or cases filed in the court system and to provide and analyze statistical data from such documents and records, and to display the results to a user is illustrated schematically in FIG. 1. Server 102 is configured by software to connect via network 104 to web sites hosted by various courts of law to search and retrieve various court documents posted by the courts of law. While many different kinds of documents, such as pleadings and written decisions of the court, for example, are typically posted on a court or other web site, statistical documents 106 prepared by each of the courts or other state or county agencies providing statistical data for cases previously filed in the courts are retrieved by the server 102 and are stored in memory 103 accessible by the server 102. For example, in the state of Idaho, such statistical documents 106 are publically available on the Idaho State Repository web site; for other states, the location or locations that such statistical documents 106 will be available from and the statistical data provided in such documents will vary. The statistical documents 106 are retrieved the web site and stored in memory 103. A search routine will search the statistical documents 106 and retrieve specific statistical data from the documents in accordance with predetermined search criteria also stored in memory 103. The retrieved statistical data is stored in database 108 in a structured manner, such as in a relational database, for example. The database 108 is updated on a periodic basis, daily or weekly, for example. The retrieved statistical documents 106 are stored and retained in memory 103 on a rotating basis, such as for 3 years, for example.

The database 108 is connected to a plurality of terminals 110 via server 112 and network 114. Although only three terminals 110 are shown in FIG. 1, it is contemplated that a greater number of terminals will be connected to database 108. The terminals 110 may be at a plurality of locations throughout one of more states in the United States and other countries throughout the world. The network 114 is a global communication network, such as the World Wide Web, referred to herein as the internet. Alternatively, a different network could be used such as local area network or telecommunications network, for example.

In one embodiment of the present disclosure, a user connects to server 112 via network 114. Through a web browser or other user interface, the server 112 presents a user one or more interactive screens providing the user with various search and analysis task criteria and displaying the results. When the user selects a desired search and analysis task, the server 108 performs a query of the database 108 using search criteria determined by the specific task selected. Predetermined criteria used to perform such searches and analyses are stored in memory 116.

Although two servers 102, 112, have been shown schematically in FIG. 1, it should be noted that servers 102, 112 may be a single unit programmed to perform the tasks performed by the servers 102, 112. As used herein, a server includes any system capable of receiving communications from a user from over a network, such as the internet, intranet, local area network, telecommunications network, and/or Ethernet. The server can comprise one or more processing units and/or include components spread across multiple physical locations. Similarly, while only a single database 108 has been shown, the database 108 could comprise a number of databases located in separate locations. These databases may be interconnected to enable data to be transmitted between databases.

A database 118 includes a list of all subscribers to the search and analysis service provided by the system 100 is stored in memory 116. As described in more detail below, when a new subscriber registers with the system 100, certain information related to the new subscriber, including an e-mail address, is requested. All information related to a subscriber is stored in database 118 and indexed by the subscriber name or other identifier. Portions of a subscriber's information is accessible by other subscribers, such as a subscriber's email address, for example. The system 100 provides various communication capabilities, including a chat room capability, for example, for all subscribers who have provided their e-mail address. Server 112 is coupled to database 118 and configured by software to support an on-line site for simultaneous communication, synchronous or asynchronous conferencing, broadcast messaging between subscribers, and uploading and downloading documents and other materials of interest to the registered users, i.e., the subscribers, of the service provided by system 100. The on-line discussion site may take the form of a chat room or bulletin board, for example. For example, a subscriber may send an e-mail with a particular question or comment to all other subscribers simultaneously. Alternatively, a subscriber may upload a comment or question, or a document, to a chat room or bulletin board, for example, that is accessible to all subscribers.

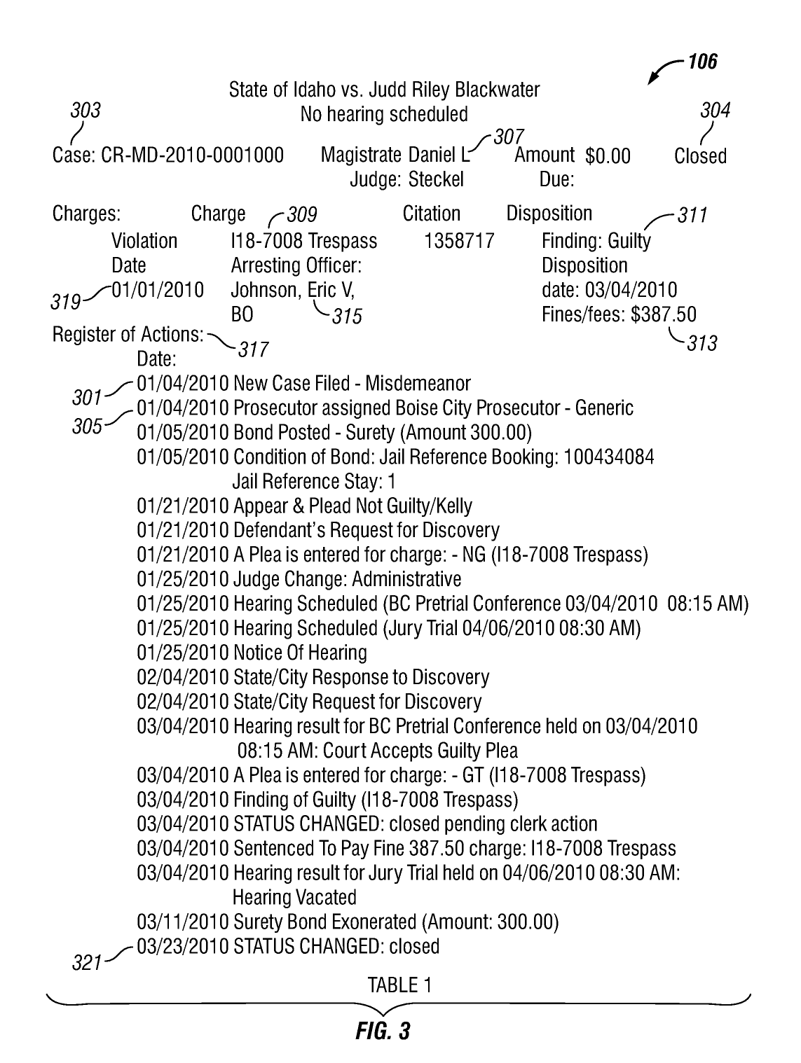

Referring now also to FIG. 2, a diagram illustrating the high level architecture 200 of the system 100 of FIG. 1 is shown. A court website 202, such as the Idaho state repository web site, for example, provides the necessary tools and processes to search cases and statistical documents for desired statistical data. When a search of a court web site is performed by server 102, as described above, the search results are retrieved in the form of html pages 204 that are stored in memory 103 or, alternatively, in a portioned portion of database 108. An example retrieved page 204 is illustrated in Table 1 shown in FIG. 3. The data parser 206 uses well-known data parsing algorithms to extract desired statistical data from the stored html pages 204 and stores the extracted data in database 208 in a structured manner. In one embodiment of the present disclosure, the extracted statistical data relates to criminal cases and may include case filing date, case number, charging agency, judge name, charge, finding by the court, jail term, fine, arresting officer, case status, order to suppress, and motion to suppress granted, for example. Alternatively, in another embodiment, the extracted statistical data may relate to civil cases and include case date, case number, plaintiff attorney, defendant attorney judge name, cause of action or charge, finding by the court, case status, order to suppress, and motion to suppress granted, for example.

As described above with reference to FIG. 1, when a user requests a search and analysis, the server 112 performs the search and any required analysis and then displays the results to the user. The server 112 includes controller 214 which formulates a requested search using predetermined search criteria stored in memory 116 and couples the search to a data abstraction module 210. The abstraction module 210 acts as an abstraction layer over the database 208 and issues appropriate search queries 212 to the database 208 to retrieve the user desired statistical data. The retrieved user data is coupled to the controller 214 via the abstraction module 210 in the appropriate format to allow the controller 214 to perform any required analysis 216 and pass the data and analysis results to the view module 218. The view module 218 constructs various screen pages to display the search results to the user in the most efficient format such as charts and graphs 222 and data tables 220. The screen pages are then displayed on user terminal 110 via a web browser or other user interface.

Referring now also to FIG. 3, a table illustrating the content of the case statistical documents 106 retrieved from court system public website is shown. As described above, the statistical documents 106 are retrieved from a court system website 202 or other state agency website as Html pages 204 and stored in memory 103. Each statistical document 106 is generated by a court system and contains a summary of statistical data related to a specific case or lawsuit for each case filed in the court system. In the example shown in FIG. 3, the statistical data provided by the statistical document 106 relates to criminal cases and includes the case filing date 301, case number 303, case status 304, charging agency 305, judge name 307, charge 309, disposition of the case 311, fine 313, arresting officer 315, date of violation 319, and a Register of Actions 317 (“ROA”), for example. The ROA 317 is a complete list of actions filed and taken before the court including the date the case was filed 301 and the date 321 the case was closed.

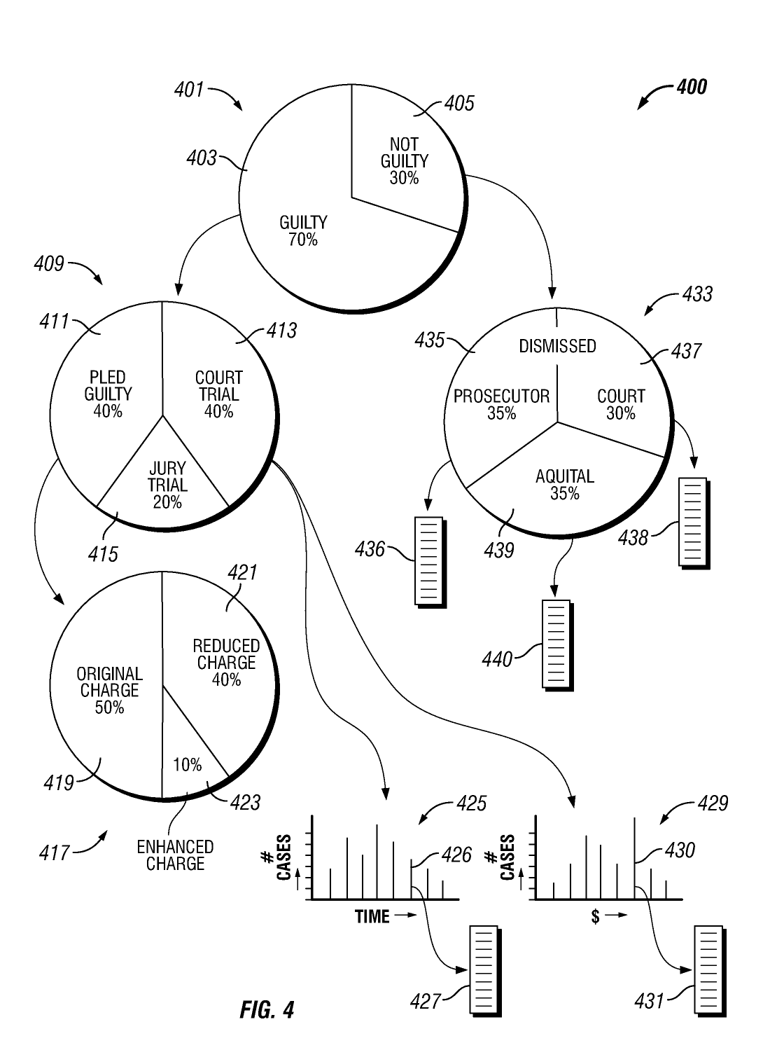

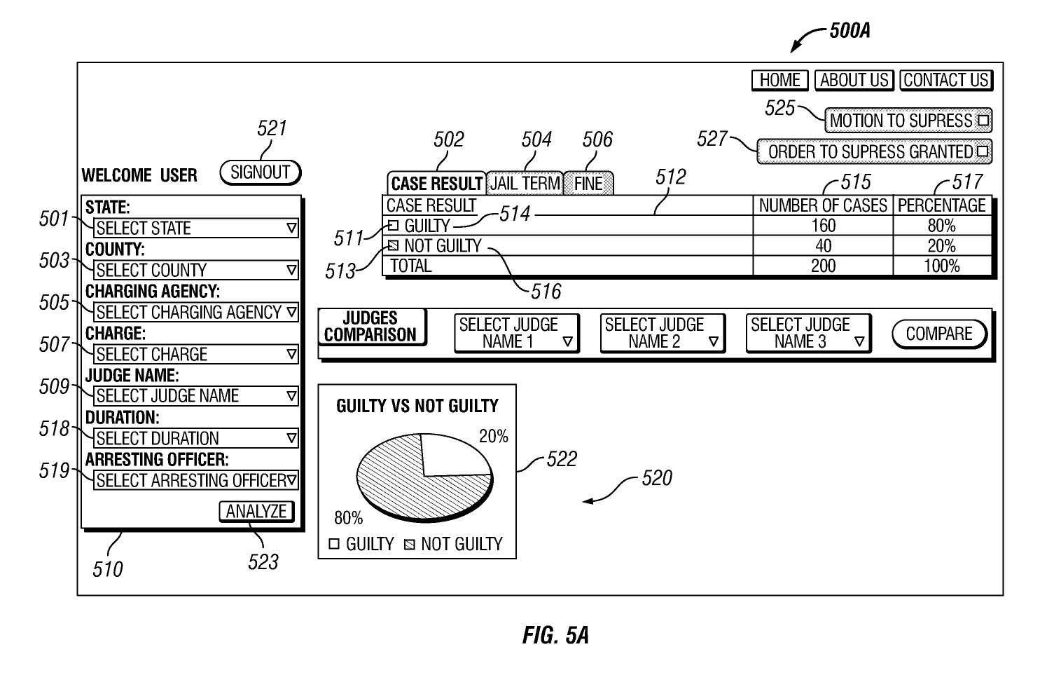

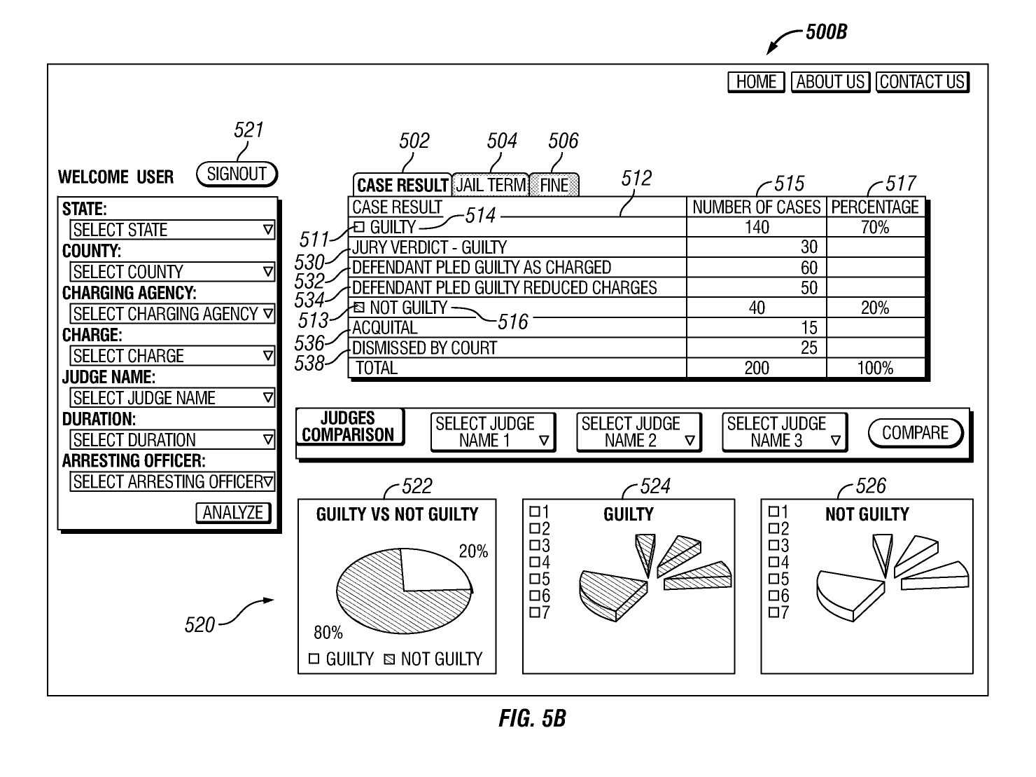

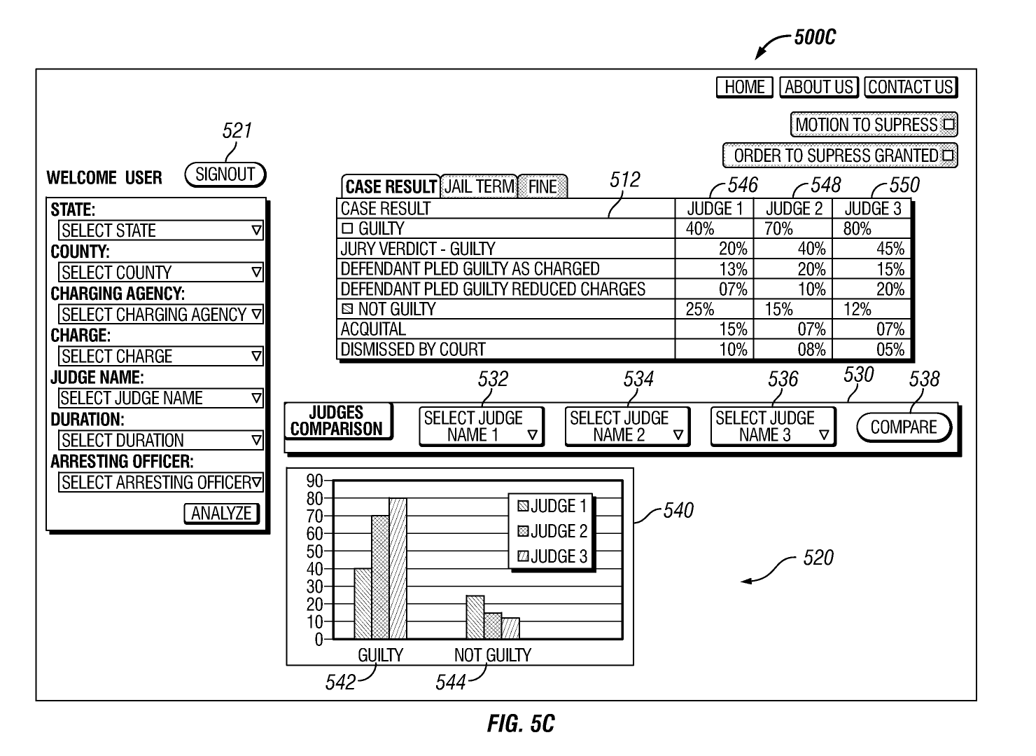

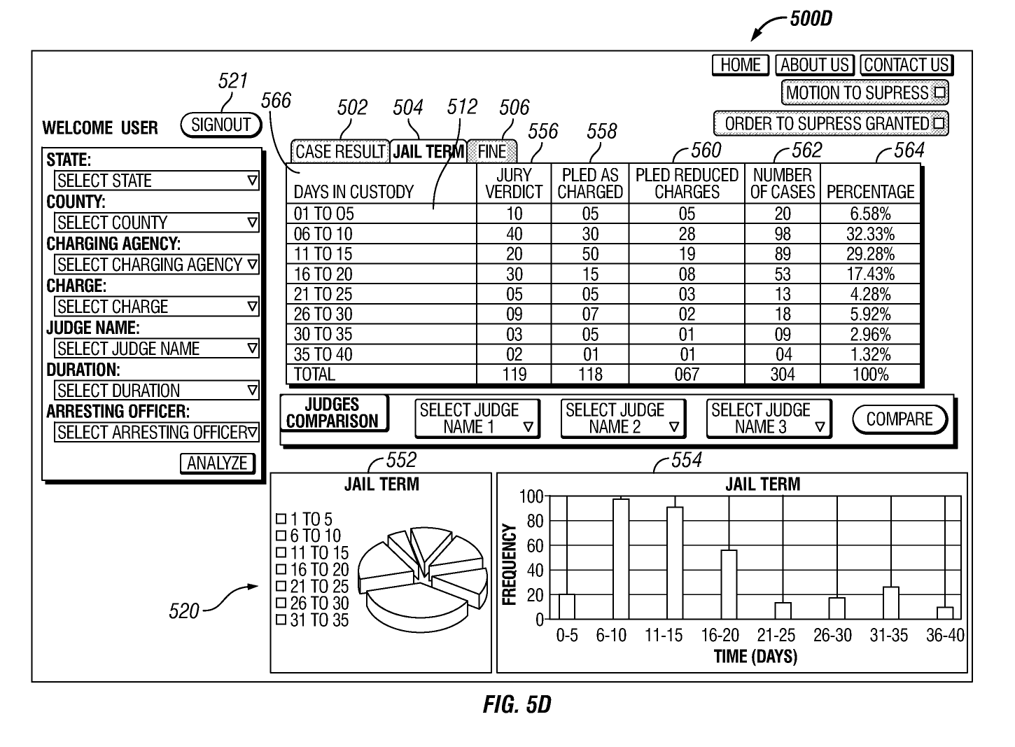

Referring now also to FIG. 4, a diagram 400 illustrating a search refinement process for a search and analysis task selection initiated by a user of the system shown in FIG. 1. A search initiated by a user all cases, driving under the influence, for example, filed in a specific county in a specific state during a specified time period, the preceding year, for example, retrieves total number of cases filed, and closed, 401 during the specified time period. Of the total number of cases 401 retrieved, seventy percent of the defendants were found guilty 403 while thirty percent of the defendants were found not guilty 405. As discussed below with reference to FIGS. 5A-5D, clicking on the guilty button 511 expands the data 409 for the seventy percent guilty 403 to show that of the guilty defendants forty percent 411 plead guilty, forty percent 413 were found guilty by the court and the remaining twenty percent 415 were found guilty by a jury. Similarly, the data 417 for the forty percent of the defendants that pled guilty 411, fifty percent 419 pled guilty to the original charge, forty percent 421 pled guilty to a reduced charge and the remaining ten percent 423 pled guilty to an enhanced charge. In another example, for the forty percent 413 of the defendants found guilty by the court, clicking on the jail term button 504 displays the jail time in a bar graph 425, for example, for the defendants that were sentenced to jail by the court. Clicking on a particular jail time period bar 426, 15-20 days, for example, provides a list of the cases filed 427 by case number that received that particular sentence. Each case number in the list 427 is a hyperlink to the court website that pulls up the statistical document corresponding to that case number. Alternatively, clicking on a case number in the list 427 will retrieve the corresponding statistical document 106 from memory 103. Similarly for the forty percent 413 of the defendants found guilty by the court, clicking on the fine button 506 displays a bar graph 429 illustrating the fine awarded by the court for each of the defendants fined by the court. Clicking on a particular fine bar 430, 100-200 dollars, for example, provides a list of the cases filed 431 by case number that received that particular fine.

In a similar manner as described above, clicking on the not guilty button 513 expands the data 433 for the thirty percent not guilty 405 to show that of the not guilty defendants thirty-five percent 435 were dismissed by the prosecutor, thirty percent 437 were dismissed by the court and the remaining thirty-five percent 439 were found not guilty, acquitted, by a jury. Clicking on the each of the data segments 435, 437, 439 for the not guilty data 433, displays a list by case number of all cases 436, 438, 440, respectively, included in each data segment. Each case number in the lists 436, 438, 440 is a hyperlink to the court website that pulls up the statistical document corresponding to that case number. Alternatively, clicking on a case number in one of the lists 436, 438, or 440 will retrieve the corresponding statistical document 106 from memory 103.

Referring now also to FIGS. 5A, 5B, 5C and 5D, FIG. 5A is a diagram of an exemplary screen page 500A presented to a user for displaying case results guilty or not guilty, for a search and analysis task request by a user of system 100 of FIG. 1. The results page 500A is divided into three sections; the search task panel 510 which allows a user to select and define a desired database search and to refine the search after the initial results are reviewed; an upper panel or results table 512 where search results are displayed in a table format; and a lower panel 520 where search results are displayed in a chart or graphical format. Panel 510 provides a number of drop down menus 501-509, 518, 519 as well as an analyze button 523 to initiate the user defined search task. Using input devices 111 such as a keyboard and/or mouse, for example, a user can specify the various attributes to be used in a search task from panel 510.

In one embodiment, the search and analysis services are organized on a state by state basis; i.e., a separate database 108 is provided for each state. The state drop down menu 501 allows the user to select which state data to search. Further, the data each state will be organized on a county basis; i.e., a separate database 108 with be constructed for each county in a state. The county drop down menu 503 allows the user to select a county to be searched. Within each county, the user can select various attributes to define the data desired. For example, within each county a charging agency 505, a charge 507, a judge 509, the duration, i.e., the time period of interest, 518 and an arresting office 519 can be selected, for example. In this embodiment, as long as a state 501, a county 503, a charge 507 and a time duration 518 are selected, and no additional attribute or attributes selected, the data retrieved from the database 108 will be the aggregate for the county selected. Once the user has defined the search, the task is initiated by clicking on the analyze button 523. While the embodiment described in this example is directed to criminal cases, it should be noted that statistical data related to other types of legal cases such as civil cases, for example, can be analyzed using the system and method disclosed herein

Positioned across the top of the results table 512 are five buttons, case result 502, jail term 504, fine 506, motion to suppress 525 and order to suppress granted 527, for example, that allow the user to specify what results are to be displayed. If the case result button 502 is clicked, the data displayed is related to results of the cases searched, guilty 514 or not guilty 516, for example. If the jail term button 504 is clicked, the data displayed relates to the amount of time, in days for example, that a defendant was sentenced to for each case result (as shown in FIG. 5D). Similarly, if the fine button 506 is clicked, the fine, in dollars, for example, that a defendant was assessed is displayed. The motion to suppress button 525 acts as a filter allowing a user to compare the results when a motion to suppress has been filed in one or more or the cases displayed. Similarly, the order to suppress granted acts as a filter allowing a user to compare the results when an order to suppress has been granted. A sign out button 521 is also provided above the search task panel 510. In the example illustrated in FIG. 5A, the case result button 502 has been clicked. The results table 512 then displays the number 515, and percentage 517 of total cases searched, of cases that resulted in guilty 514 or not guilty 516 decisions. The lower panel 520 displays the same information as results table 512, but in a pie chart 522 format. The search results exemplified in the results page 500A shown in FIG. 5A are for a search task in which only the charge 507 attribute, driving under the influence, for example, and a duration 518, one year, for example, attribute were specified, along with the state 501 and county 503. The results displayed are for the total number of cases filed in the selected state and county for the specified duration (time period). If, for example, a specific judge 509 had also been selected, then the data displayed in table 512 and chart 522 would have reflected only cases handled by the selected judge. Similarly, if a specific charging agency 505 and/or a specific arresting officer 519 had also been selected in addition to a specific judge, then the data displayed would reflect only the cases initiated by the selected charging agency, selected arresting officer and handled by the specific judge selected.

FIG. 5B is a diagram of an exemplary screen page 500B presented to a user for displaying case results guilty 514 or not guilty 516, for a search and analysis task request by a user of system 100 of FIG. 1. Results page 500B is similar to results page 500A in all respects; for example, results page 500B is divided into a left panel 406, an upper panel 512 and a lower panel 520. The guilty 514 and not guilty 516 results along with the numbers 515 and percentages 517 are shown in results table 512; results page 500B displays additional data compared to results page 500A shown in FIG. 5A. A guilty button 511 is positioned at the left end of the guilty 514 line in the results table 512. Similarly a not guilty button 513 is positioned at the left end of the not guilty 516 line in the results table 512. Clicking on the guilty button 511 expands the guilty results providing greater detail for the cases in which a guilty decision was reached. In this example, the guilty 514 results have been expanded to indicate the number and percentage of total cases in which a jury returned a guilty verdict 530, defendant plead guilty as charged 532, and defendant plead guilty to reduced charges 534. Similarly, clicking on the not guilty button 513 provides a breakdown of the not guilty results; number and percentage of total cases in which the defendant was found not guilty 536 and defendant's case was dismissed by the court 538. The expanded results are also displayed in the lower panel 520 as pie chart 522 illustrating guilty versus not guilty, pie chart 524 illustrating the breakdown of the guilty decisions, and pie chart 526 illustrating the breakdown of the not guilty decisions.

Referring now also to FIG. 5C, a diagram of an exemplary screen page 500C presented to a user for displaying case results guilty 514 or not guilty 516, for a search and analysis task request by a user of system 100 of FIG. 1 is shown. As described above with reference to FIGS. 5A and 5B, the data displayed in the figures resulted from a search that named only the state 501, the county 503, the specific charge 507 for a selected time duration 518. As shown in each of the FIGS. 5A, 5B, 5C and 5D, a judge's comparison panel 530 provides three drop down menus 532, 534, 536 that allow a user to select up to three judges from the county 503 specified in the search task. The three drop down menus 532, 534, 536 display only the names of the judges in the selected county 503. In order to determine how specific judges compare to one another for all cases related to a specific charge and handled by one of three judges sitting in the selected county 503, a user selects the names of three judges from the drop down menus 532, 534, 536 and clicks on the compare button 538. The results of the comparison are then displayed in a graphical format in graph 540 appearing in lower panel 520. The data is displayed as the percentage of the cases heard by each judge that resulted in a guilty 542 decision and the percentage of cases heard by each judge that result in a not guilty 544 decision. The comparison results are also displayed in results table 512. The results for each of the selected judges is tabulated in one of three columns at the right side of results table 512, judge 1, column 546, judge 2, column 548, and judge 3, column 550.

Referring now also to FIG. 5D, a diagram of an exemplary screen page 500D presented to a user for displaying case results guilty 514 or not guilty 516, for a search and analysis task request by a user of system 100 of FIG. 1 is shown. In the example shown in FIG. 5D, the jail term button 504 has been clicked, and the jail sentence, in days, for example, awarded to the defendant in each of the cases retrieved by the search selected in FIG. 5A that resulted in a guilty result is displayed. For example, results table 512 tabulates the data in several columns at the right side of the table. Column 556 provides the number of cases that resulted in a guilty verdict by a jury; column 558 provides the number of cases in which the defendant plead guilty to the charges as originally filed; column 560 provides the number of cases in which the defendant plead guilty to reduced charges; column 562 provides the number of cases receiving a particular jail term; and column 564 provides the percentage of the total number of cases retrieved by the search (as defined above with reference to FIG. 5A) that received a particular jail term. In the lower panel 520, the results are displayed in a pie chart 552 format illustrating the percentage of the total number of cases receiving a particular jail term. The results are also shown in a graphical format in the bar graph 554 illustrating the percentage of the total number of cases receiving a particular jail term.

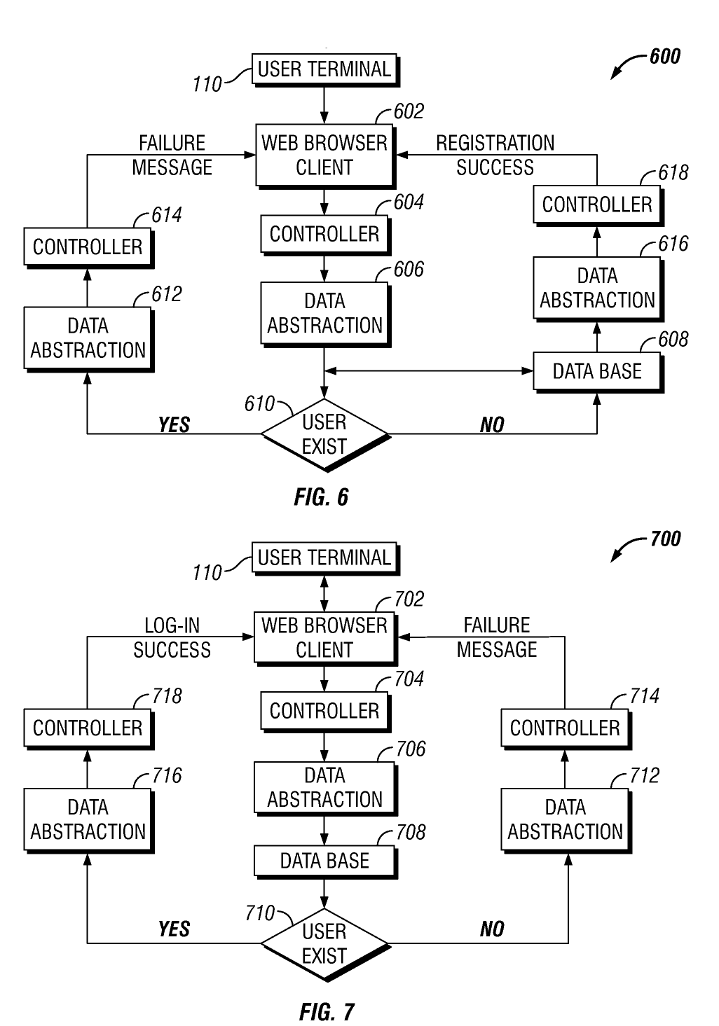

Referring now also to FIG. 6, a flow chart 600 illustrating the registration process for a new user or subscriber of the system of FIG. 1 is shown. When a user first visits a web site for the search services provided by the system of the present disclosure, the new user is required to register. The new user initiates the registration procedure at a home page (not shown) at user terminal 110. When the register button is clicked, the web browser 602 displays a registration page (not shown) which requires the new user to enter certain information such as name, company, contact information, e-mail address, and the like, for example. The registration page also requires the new user to select a user name and password. Once the required information has been entered, the information is transmitted to a controller 604, at server 108 as shown in FIG. 1. The controller 604 first checks the submitted user information for accuracy and completeness and then passes the information to the data abstraction module 606. At the data abstraction module 606, an initial query is transmitted to the database 608 to determine whether the user is already registered and in the data base. In the event the user already exists 610 in the database 608, the data abstraction module at 612 transmits a failure message to the controller at 614. The controller 614 then formats a message to be displayed at terminal 110 via the web browser 602 informing the user that the user already exists in the database and directing the user to log in. If the new user does not already exist 610 in the database, the user information provided on the registration page at the web browser 602 is passed to the database at 608 where the user information indexed by the user's user name and password is stored. The data abstraction module at 616 then transmits a success message to the controller at 618. The controller 618 then formats a message to be displayed at terminal 110 via web browser 602 informing the user that registration is complete.

Referring now also to FIG. 7, a flow chart 700 illustrating the login process for a user of the system of FIG. 1 is shown. When a returning user visits a web site for the search services provided by the present disclosure, the user is required to log in to use the service. The user initiates the log in procedure by clicking on a sign in button provided on the home page (not shown) at user terminal 110. When the sign in button is clicked, the web browser 702 displays a sign in page (not shown) which requires the user to enter the user's user name and password. Once the required information has been entered, the information is transmitted to a controller 704, at server 108 as shown in FIG. 1. The controller 704 first checks the submitted log in information for completeness and then passes the information to the data abstraction module 706. At the data abstraction module 706, a query is transmitted to the database 708 to determine whether the user is registered and in the data base. If the user's user name and password does not match 710 any user information stored in the database 708, the data abstraction module at 712 transmits a failure message to the controller at 714. The controller 714 then formats a message to be displayed at terminal 110 via the web browser 702 informing the user that log in failed. If the user's user name and password match 710 any user information stored in the database 708, the data abstraction module at 716 then transmits a success message to the controller at 718. The controller 718 then formats a message to be displayed at terminal 110 via web browser 702 informing the user that log in was successful. In the event that the user successfully logs in, the controller at 718 also displays, via web browser 702, task selection screen as described above with reference to FIG. 4.

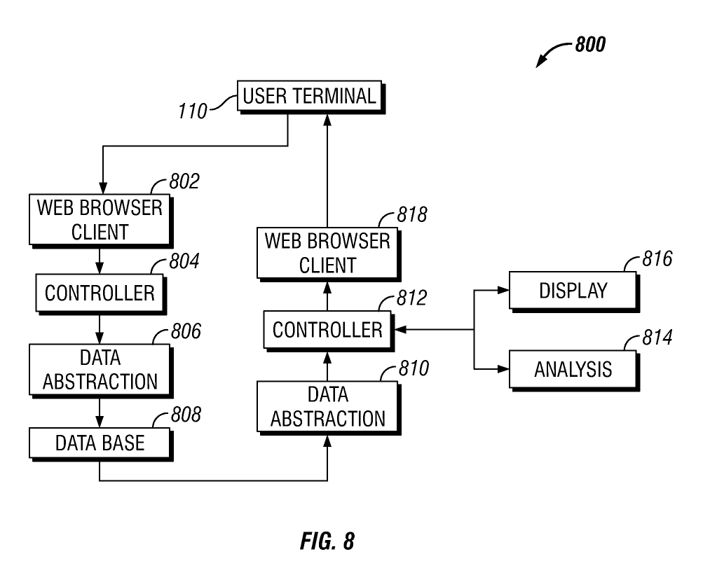

Referring now also to FIG. 8, a flow chart 800 illustrating the search and analysis process for the system of FIG. 1 is shown. As discussed above with reference to FIG. 5A, a user at user terminal 110 selects and defines a desired search task using the task selection panel 510 displayed by the web browser at 802. When the user has completed the task definition process, the search request is transmitted to a controller at 804. The controller 804 checks the requested search for accuracy, completeness and consistency and then transmits the search request to the data abstraction module at 806. Using the information submitted in the search request, the data abstraction module 806 formulates the appropriate queries and passes the search request to the database at 808. The database at 808 retrieves the requested data and passes the retrieved data to the data abstraction module at 810. The data abstraction module at 810 provides the retrieved data to the controller in the appropriate format. The controller at 812 utilizing the analysis module 814 and the display module 816 provides the requested search results displayed in appropriate formats to the web browser at 818. The web browser 818 then displays the search results at user terminal 110.

Although the present disclosure has been described in terms of certain embodiments, other embodiments that are apparent to those of ordinary skill in the art, including embodiments which do not provide all of the features and advantages set forth herein, are also within the scope of this disclosure. Accordingly, the scope of the present disclosure is defined by the claims that follow.

What is claimed is:

1. A method of searching and disseminating statistical information relating to lawsuits filed in a plurality of courts of law comprising the steps of:
retrieving statistical documents generated by at least one court of law of a plurality of courts of law, the statistical documents relating to at least one lawsuit filed in the at least one court of law;
reviewing and extracting statistical data from the retrieved statistical documents in accordance with a predetermined set of search criteria, the extracted statistical data including at least an identifier of a lawsuit, the location of the court of law that tried the at least one lawsuit, the cause of action for the at least one lawsuit, the date that the lawsuit was closed, and the disposition of the at least one lawsuit for each lawsuit filed in the at least one court of law of the plurality of courts of law;
storing the extracted statistical data in a database;
accessing the database with a plurality of user terminals which communicate with the database via a network; and
providing a least a portion of the stored extracted statistical data from the database over the network to at least one user located at a user terminal in response to a user request.

2. The method of claim 1, further comprising the step of storing the retrieved statistical documents in a memory.

3. The method of claim 1, wherein the extracted statistical data includes the name of a judge that tried the at least one lawsuit and, in the case of a criminal offense, the identity of an agency that filed the lawsuit, the name of a prosecuting attorney that represented the agency that filed the lawsuit, the identity of an arresting officer, and a sentence awarded in the lawsuit by the court of law that tried the lawsuit.

4. The method of claim 3, further comprising the step of analyzing the extracted statistical data to determine at least one predefined relationship between the total number of lawsuits for a selected cause of action filed in a selected group of courts of law of the plurality of courts of law and the disposition of each lawsuit filed and closed in the selected group of courts of law of the plurality of courts of law during a selected time period, and providing statistical data from the database to the at least one user terminal indicative of the relationship between the number of lawsuits for a selected cause of action filed in the selected group of courts of law and the disposition of each lawsuit filed and closed in the selected group of courts of law during the selected time period.

5. The method of claim 3, further comprising the step of analyzing the extracted statistical data to determine at least one predefined relationship between the total number of lawsuits for a selected cause of action filed and closed in a selected group of courts of law and the disposition of each lawsuit for the selected cause of action filed and closed in the selected group of courts of law tried by a selected judge during the selected time period, and providing statistical data from the database to the at least one user terminal indicative of the relationship between the number of lawsuits for a selected cause of action filed in the selected group of courts of law and the disposition of each lawsuit for the selected cause of action filed and closed in the selected group of courts of law tried by the selected judge during the selected time period.

6. The method of claim 3, further comprising the step of analyzing the extracted statistical data to determine at least one predefined relationship between the total number of lawsuits for a selected cause of action filed and closed in a selected group of courts of law and the disposition of each lawsuit for the selected cause of action filed and closed in the selected group of courts of law tried by each judge of a plurality of selected judges during the selected time period, and providing statistical data from the database to the at least one user terminal indicative of the relationship between the number of lawsuits for the selected cause of action filed in the selected group of courts of law and the disposition of each lawsuit for the selected cause of action filed and closed in the selected group of courts of law tried by each judge of the plurality of selected judges during the selected time period.

7. The method of claim 3, in the case of a criminal lawsuit, the deposition of a lawsuit being either guilty or not guilty, further comprising the step of analyzing the extracted statistical data to determine at least one predefined relationship between the total number of lawsuits for a selected cause of action filed and closed in a selected group of courts of law and each lawsuit for the selected cause of action filed and closed in the selected group of courts of law for which the disposition was guilty and each lawsuit for the selected cause of action filed and closed in the selected group of courts of law for which the disposition was not guilty during the selected time period, and providing statistical data from the database to the at least one user terminal indicative of the relationship between the number of lawsuits for the selected cause of action filed in the selected group of courts of law and each lawsuit for the selected cause of action filed and closed in the selected group of courts of law for which the disposition was guilty and each lawsuit for the selected cause of action filed and closed in the selected group of courts of law for which the disposition was not guilty during the selected time period.

8. The method of claim 7, further comprising the step of analyzing the extracted statistical data to determine at least one predefined relationship between the total number of lawsuits for a selected cause of action filed and closed in the selected group of courts of law and each lawsuit for the selected cause of action filed and closed in the selected group of courts of law for which the disposition was guilty and each lawsuit for the selected cause of action filed and closed in the selected group of courts of law for which the disposition was not guilty tried by one judge during the selected time period, and providing statistical data from the database to the at least one user terminal indicative of the relationship between the number of lawsuits for a selected cause of action filed and closed in the selected group of courts of law and each lawsuit for the selected cause of action filed and closed in the selected group of courts of law for which the disposition was guilty and each lawsuit for the selected cause of action filed and closed in the selected group of courts of law for which the disposition was not guilty tried by the one judge during the selected time period.

9. The method of claim 7, further comprising the step of analyzing the extracted statistical data to determine at least one predefined relationship between the total number of lawsuits for a selected cause of action filed and closed in the selected group of courts of law and each lawsuit for the selected cause of action filed and closed in the selected group of courts of law for which the disposition was guilty and each lawsuit for the selected cause of action filed and closed in the selected group of courts of law for which the disposition was not guilty tried by each judge of a plurality of selected judges during the selected time period, and providing statistical data from the database to the at least one user terminal indicative of the relationship between the number of lawsuits for a selected cause of action filed and closed in the selected group of courts of law and each lawsuit for the selected cause of action filed and closed in the selected group of courts of law for which the disposition was guilty and each lawsuit for the selected cause of action filed and closed in the selected group of courts of law for which the disposition was not guilty tried by each judge of a plurality of selected judges during the selected time period.

10. The method of claim 7, further comprising the step of analyzing the extracted statistical data to determine at least one predefined relationship between the total number of lawsuits for a selected cause of action filed and closed in a selected group of courts of law for which the disposition was guilty and each lawsuit for the selected cause of action filed and closed in the selected group of courts of law in which a defendant pled guilty, and each lawsuit for the selected cause of action filed and closed in the selected group of courts of law in which a defendant was found guilty by a court of law, and each lawsuit for the selected cause of action filed and closed in the selected group of courts of law in which a defendant was found guilty by a jury, and providing statistical data from the database to the at least one user terminal indicative of the relationship between the number of lawsuits for the selected cause of action filed and closed in the selected group of courts of law for which the disposition was guilty and each lawsuit for the selected cause of action filed and closed in the selected group of courts of law in which a defendant pled guilty, and each lawsuit for the selected cause of action filed and closed in the selected group of courts of law in which a defendant was found guilty by a court of law, and each lawsuit for the selected cause of action filed and closed in the selected group of courts of law in which a defendant was found guilty by a jury during the selected time period.

11. The method of claim 7, further comprising the step of analyzing the extracted statistical data to determine at least one predefined relationship between the total number of lawsuits for a selected cause of action filed and closed in a selected group of courts of law for which the disposition was not guilty and each lawsuit for the selected cause of action filed and closed in the selected group of courts of law in which a lawsuit was dismissed, and each lawsuit for the selected cause of action filed and closed in the selected group of courts of law in which a defendant was acquitted by a court of law, and providing statistical data from the database to the at least one user terminal indicative of the relationship between the number of lawsuits for the selected cause of action filed and closed in the selected group of courts of law for which the disposition was not guilty and each lawsuit for the selected cause of action filed and closed in the selected group of courts of law in which a lawsuit was dismissed and each lawsuit for the selected cause of action filed and closed in the selected group of courts of law in which a defendant was acquitted by a court of law during the selected time period.

12. The method of claim 10, further comprising the step of analyzing the extracted statistical data for the total number of lawsuits for a selected cause of action filed and closed in a selected group of courts of law for which the disposition was guilty to determine the lawsuit identifier for each lawsuit for the selected cause of action filed and closed in the selected group of courts of law in which a defendant pled guilty, and to determine the lawsuit identifier for each lawsuit for the selected cause of action filed and closed in the selected group of courts of law in which a defendant was found guilty by a court of law, and to determine the lawsuit identifier for each lawsuit for the selected cause of action filed and closed in the selected group of courts of law in which a defendant was found guilty by a jury, and providing statistical data from the database to the at least one user terminal indicative of the lawsuit identifier for each lawsuit for the selected cause of action filed and closed in the selected group of courts of law in which a defendant pled guilty, and to provide the lawsuit identifier for each lawsuit for the selected cause of action filed and closed in the selected group of courts of law in which a defendant was found guilty by a court of law, and to provide the lawsuit identifier for each lawsuit for the selected cause of action filed and closed in the selected group of courts of law in which a defendant was found guilty by a jury during the selected time period.

13. The method of claim 12, wherein the lawsuit identifier comprises a hyperlink directing the user to a public database where the statistical document corresponding to the lawsuit identifier is stored and enabling the user to retrieve the statistical document corresponding to the lawsuit identifier.

14. The method of claim 12, wherein the retrieved statistical documents are stored in a memory, the lawsuit identifier comprises a link to the retrieved statistical document corresponding to the lawsuit identifier and enabling the user to retrieve the retrieved statistical document corresponding to the lawsuit identifier.

15. The method of claim 11, further comprising the step of analyzing the extracted statistical data for the total number of lawsuits for a selected cause of action filed and closed in a selected group of courts of law for which the disposition was not guilty to determine the lawsuit identifier for each lawsuit for the selected cause of action filed and closed in the selected group of courts of law in which a lawsuit was dismissed, and to determine the lawsuit identifier for each lawsuit for the selected cause of action filed and closed in the selected group of courts of law in which a defendant was acquitted by a court of law, and providing statistical data from the database to the at least one user terminal indicative of the lawsuit identifier for each lawsuit for the selected cause of action filed and closed in the selected group of courts of law for which the disposition was not guilty to provide the lawsuit identifier for each lawsuit for the selected cause of action filed and closed in the selected group of courts of law in which a lawsuit was dismissed and to provide the lawsuit identifier for each lawsuit for the selected cause of action filed and closed in the selected group of courts of law in which a defendant was acquitted by a court of law during the selected time period.

16. The method of claim 15, wherein the lawsuit identifier comprises a hyperlink directing the user to a public database where the statistical document corresponding to the lawsuit identifier is stored and enabling the user to retrieve the statistical document corresponding to the lawsuit identifier.

17. The method of claim 15, wherein the retrieved statistical documents are stored in a memory, the lawsuit identifier comprises a link to the retrieved statistical document corresponding to the lawsuit identifier and enabling the user to retrieve the retrieved statistical document corresponding to the lawsuit identifier.

18. The method of claim 10, further comprising the step of analyzing the extracted statistical data for the total number of lawsuits for a selected cause of action filed and closed in a selected group of courts of law for which the disposition was guilty to determine the sentence awarded by the court in each lawsuit for which the disposition was guilty, and providing statistical data from the database to the at least one user terminal indicative of the sentence awarded by the court in each lawsuit for which the disposition was guilty.

19. The method of claim 18, further comprising the step of analyzing the extracted statistical data for the total number of lawsuits for a selected cause of action filed and closed in a selected group of courts of law for which the disposition was guilty and the sentence awarded by the court in each lawsuit for which the disposition was guilty included a fine to determine the amount of the fine for each lawsuit for which the sentence included a fine, and providing statistical data from the database to the at least one user terminal indicative of the amount of the fine for each lawsuit for which the disposition was guilty and the sentence awarded by the court included a fine.

20. The method of claim 19, further comprising the step of analyzing the extracted statistical data for the total number of lawsuits for a selected cause of action filed and closed in a selected group of courts of law for which the disposition was guilty and the sentence awarded by the court in each lawsuit for which the disposition was guilty included a fine to determine the lawsuit identifier for each such lawsuit for which the amount of the fine was within at least one predetermined range of values for the amount of the fine, and providing statistical data from the database to the at least one user terminal indicative of the lawsuit identifier for each such lawsuit for which the amount of the fine was within at least one predetermined range of values for the amount of the fine.

21. The method of claim 18, further comprising the step of analyzing the extracted statistical data for the total number of lawsuits for a selected cause of action filed and closed in a selected group of courts of law for which the disposition was guilty and the sentence awarded by the court in each lawsuit for which the disposition was guilty included a jail term of at least one day to determine the amount of time for the jail term for each lawsuit for which the sentence included a jail term of at least one day, and providing statistical data from the database to the at least one user terminal indicative of the amount of time for the jail term for each lawsuit each lawsuit for which the disposition was guilty and the sentence awarded by the court included a jail term of at least one day.

22. The method of claim 21, further comprising the step of analyzing the extracted statistical data for the total number of lawsuits for a selected cause of action filed and closed in a selected group of courts of law for which the disposition was guilty and the sentence awarded by the court in each lawsuit for which the disposition was guilty included a jail term of at least one day to determine the lawsuit identifier for each such lawsuit for which the amount of time for the jail term was within at least one predetermined range of values for the amount of time for the jail term, and providing statistical data from the database to the at least one user terminal indicative of the lawsuit identifier for each such lawsuit for which the amount of time for the jail term was within at least one predetermined range of values for the amount of the jail term.

23. The method of claim 1, further comprising the step of storing of user related information, the user related information including at least a list of all registered users of the system and an email address for each of the registered users of the system.

24. The method of claim 23, further comprising the step of facilitating an on-line discussion site accessible by all of the registered users allowing registered users to post comments and questions to all registered users, and upload and download documents and other materials of interest to the registered users.

25. A system for searching and disseminating statistical information relating to lawsuits filed in a plurality of courts of law comprising:
a server coupled to a public database via a network, the public database storing a plurality of statistical documents, each statistical document including data related to a lawsuit filed in at least one of a plurality of courts of law, the server operative to retrieve and store the statistical documents;
a search module operative to search and extract statistical data from the retrieved statistical documents in accordance with a stored set of predetermined search criteria, said extracted statistical data including at least an identifier of a lawsuit, the location of a court of law that tried the lawsuit, the cause of action for the lawsuit, the date that the lawsuit was closed, and the disposition of the lawsuit for each lawsuit filed in a court of the plurality of courts of law;
storage for a database of the extracted statistical data, the server being operative to access the database in response to a search request; and
the server coupled to at least one user terminal over a network, the server operative to provide at least a portion of the stored extracted statistical data to at least one user terminal in response to a user search request.

26. The system of claim 25, wherein the extracted statistical data includes the name of a judge that tried a lawsuit, and, in the case of a criminal offense, the identity of an agency that filed the lawsuit, the name of a prosecuting attorney that represented the agency that filed the lawsuit, and the sentence awarded by a court of law that tried the lawsuit.

27. The system of claim 26 further comprising an analysis module operative to determine at least one predefined relationship between the total number of lawsuits for a selected cause of action filed in the at least one court of law of a plurality of courts of law and the dispositions of each lawsuit for the selected cause of action filed and closed during a selected time period.

28. The system of claim 26 further comprising an analysis module operative to determine at least one predefined relationship between the total number of lawsuits for a selected cause of action filed in the at least one court of law of a plurality of courts of law and the dispositions of each lawsuit for the selected cause of action filed and closed in the at least one court of law tried by each judge of a plurality of selected judges during a selected time period.

29. The system of claim 26 further comprising a user interface coupled to the server over the network, wherein the user interface receives the user search request from a user over the network, the search request being indicative of the search work product that the user desires to create, the search request being formulated using a plurality of selectable search criteria.

30. The system of claim 29 wherein the user interface allows the user to select specific search criteria from a plurality of groups of search criteria, the groups of search criteria including at least a judge name, cause of action, state, county, time duration and charging agency.

31. The system of claim 25, further comprising storage for a database of user related information, the user related information including at least a list of all registered users of the system and an email address for each of the registered users of the system.

32. The system of claim 32, the server being operative to access the database and facilitate an on-line discussion site accessible by all of the registered users allowing registered users to post comments and questions to all registered users, and upload and download documents and other materials of interest to the registered users.
